(19) United States
(12) Patent Application Publication
(10) Pub. No.: US 2011/0281131 A1
(43) Pub. Date: Nov. 17, 2011

(54) DECORATIVE TRIM PANEL

(76) Inventor: Richard A. Roberts, Orem, UT (US)

(21) Appl. No.: 12/781,512

(22) Filed: May 17, 2010

(51) Int. Cl. B32B 7/04; B29C 53/36

(52) U.S. Cl. 428/542.2; 156/217

(57) ABSTRACT

Decorative trim panels and methods for manufacturer are described. An example decorative planar material usable for producing the decorative trim panels may include a substrate layer, a decorative laminate layer attached to the substrate layer, and a substantially transparent coating layer permanently attached to the decorative laminate layer. The decorative planar material may be modified to produce decorative trim by making one or more cuts through the substrate and decorative laminate layers, but not extending significantly into the coating layer. The one or more cuts may physically separate the substrate and laminate layers into different portions that may then be bent at tight bend radii. The tight radii may be produced by using a single bend or a compound bend creating beveled edge. The coating layer permanently holds the physically separate portions together even after installation and use.

### BACKGROUND

1. Field of the Invention

The present disclosure relates to decorative materials. More particularly, the present disclosure relates to decorative materials that include laminate materials formed into boundary panels that provide a finished boundary or edge for dry and moisture sensitive locations.

2. Background

A variety of different types of materials are usable to provide a decorative or other aesthetic appeal on tub and shower surrounds, countertops, windows, cabinet doors, cabinet drawer facings, and in a number of other indoor and outdoor applications. The materials used for such purpose may include natural or manufactured materials. For instance, natural materials such as stone, or manufactured materials such as porcelain tile or plastic laminate may be used on a countertop or on a bathtub or shower surround.

Although the popularity of natural stone materials and other natural or organic materials has risen in recent years, the demand for plastic laminate and other similar materials has also continued to increase. The increased demand for plastic laminate materials has at least in part resulted from an increase in the quality and aesthetic appeal of such decorative laminate materials. For example, different types of laminate materials are now be available that have a surface appearance that is virtually indistinguishable from natural materials, or that is otherwise equally aesthetically pleasing as natural materials. Additionally, the quality of materials has increased such that plastic laminate materials are increasingly resistant to wear, melting, delamination, or other damage.

The demand for plastic laminate materials is also influenced by monetary concerns. For example, the cost to produce and/or install tile or natural materials is often more than four or five times the cost for producing and/or installing laminate materials for a similar application. Moreover, plastic or other laminate materials are often non-porous, and can thus be used in applications that are exposed to moisture, whereas many natural or other materials have porous properties that, if used in moisture-sensitive applications, require periodic sealing be performed so as to enable the materials to be suitably moisture resistant.

While plastic and other laminate materials thus provide a large number of benefits over other available materials, there have been certain limitations on their uses. For instance, plastic laminates are typically produced as thin-sheets that are then attached directly to a wall or other surface, or which may be applied to a substrate (e.g., a particle board countertop) and installed. The laminate materials are often brittle at room temperature, and become pliable only after being heated. Even when subject to heat, however, the pliability of the laminate materials may be limited and the minimum available bend radius may remain relatively large.

For instance, some of the more popular laminate materials are produced under the trade name Formica®. The manufacturer of Formica® branded laminate has specified that its products have only a limited flexibility even when heated, and has thus recommends a minimum allowable bend radius of no less than four inches for its most flexible products. Other products may be even more brittle, and may have a minimum allowable bend radius of up to eighteen inches. Where tighter radii are needed, the manufacturer of Formica® products indicates that the products must be machined.

When tile or other materials are installed, specific boundary tiles or materials may be used to provide a finished boundary edge that obscures underlying materials, adhesives, and the like. Because of the inability to form curves at tight radii, or to do so only with costly and time consuming machining, laminate materials typically are not available with coordinating edge molding or trim pieces that would otherwise be available for other products. Moreover, Formica® and other types of plastic laminate may have details, coloring, textures, or other features that make them difficult or impossible to reproduce on a suitable medium that can be bent to a desired shape, so that it is difficult or impossible to create artificial reproductions for use as boundary pieces.

Accordingly, it would be desired to provide methods and articles of manufacture for producing boundary, edge, trim and/or molding for use in a variety of applications and with different materials, notwithstanding the flexibility limitations of laminate materials. The subject matter described and claimed herein is not limited to embodiments that solve any disadvantages or that operate only in environments such as those described above. Rather, this background is provided to illustrate one exemplary technology area where some embodiments described herein may be practiced.

### BRIEF SUMMARY

One embodiment of the present disclosure includes an article of manufacture that includes a decorative planar material. The decorative planar material may include a substrate layer with a decorative laminate layer attached thereto. A substantially transparent coating layer may be permanently attached to the decorative laminate layer. The substrate and/or decorative laminate layers may each also be separated into multiple portions. The substantially transparent coating layer may also be a single portion that permanently attaches to the multiple portions of the decorative laminate layer.

In some embodiments, a decorative planar material includes one or more cuts that separate the substrate layer into first and second portions. The one or more cuts may also separate a decorative laminate layer into first and second portions that are aligned with the first and second substrate portions. The transparent coating optionally is a single, integral layer permanently adhered or otherwise attached to the first and second decorative laminate portions. The one or more cuts may cause first and second substrate portions to be physically separate, and/or may also physically separate first and second decorative laminate portions.

The decorative planar material may have portions of a layer offset at angles from each other. For instance, adjacent portions of a decorative layer may be offset at an angle. That angle may be an obtuse angle. Portions of a decorative layer may also be offset at other angles, and different decorative layer portions may be, for example, offset at a right angle. In some embodiments, portions offset at a right angle are separated by a third portion disposed therebetween and offset at an angle relative to each. For instance, the intermediate portion may be at an obtuse angle from each of two adjacent portions. The decorative laminate and substrate layers may define a beveled edge that approximates a tight curve radius with physically separate decorative laminate portions, while a coating layer maintains separate decorative laminate layers adjacently positioned.

In another embodiment, an article of manufacture relates to a decorative trim panel that includes a decorative planar material composed of multiple layers. The multiple layers may include a substrate layer, a decorative layer, and a coating layer, each of which are substantially parallel. The decorative layer may be wholly or partially composed of a laminate material that has a minimum allowable bend radius about at which the laminate material breaks, and the coating layer may be permanently attached to the decorative layer. One or more cuts may be formed in the decorative planar material. The cuts may be formed through the substrate layer and at least a portion of the decorative layer, without substantially extending into the coating layer. A finished end feature may be included on the trim. The finished end feature may include a bend in the decorative planar material at a bend radius less than the minimum allowable bend radius of the laminate material.

In some embodiments, substrate and coating layers of a decorative trim panel are attached to opposing surfaces of a decorative layer. The coating layer may also be attached to substantially a full area of a corresponding surface of the decorative layer. In some embodiments, a cut is formed in the decorative planar material to form a substantially triangular cross-sectional shape within a substrate layer. A bend in a finished end feature may be near one or more cuts, and the bend may be a compound bend. The at least one cut may separate the substrate and decorative layers each into two or more respective portions, and the two portions of each of the substrate and decorative layers may be angled relative to each other at an about ninety degrees or at a larger angle. For instance, the angle may be obtuse. A coating layer may also finish the end feature by being flexible, such that the flexible material is bent at the bend to permanently cover the at least one cut and to permanently cover the physically separate portions of the decorative layer.

In still another embodiment, a method for forming a decorative trim panel from at least laminate material is described, and may produce trim panels with one or more bends at radii below the minimum allowable bend radius that typically causes the laminate material to break. In such a method, a decorative planar material may be bent by approximating a bend angle. Bending the decorative planar material in this manner may include forming a plurality of portions in the decorative planar material. Different portions may be formed by separating a substrate layer of the planar material into two or more portions, and also separating a decorative laminate layer into two or more portions that correspond to the portions in the substrate layer. The portions of the decorative laminate layer may remain at least indirectly attached through a coating layer that is permanently attached to the two or more decorative portions. The second substrate portion and second decorative portion may be rotated relative to the first substrate and decorative portions.

In producing a decorative trim panel, a bend that is produced may be finished at an approximated bend angle. Finishing the bend may performed automatically by a coating layer. For instance, a flexible coating layer permanently attached to a decorative layer may finish the bend without being removed, and without machining or grinding of an external surface of the trim panel. The coating layer may maintain different portions of the decorative layer adjacent to each other both during and after rotation relative to each other, such that that the edge surface of the bend has a finished and optionally smooth appearance or configuration.

In some embodiments, multiple portions may be formed in a decorative player material by making multiple cuts in a substrate layer and in a decorative layer. The cuts may not extend through a coating layer. Multiple cuts may also be made to extend at diverging angles in a manner that defines three substrate portions and three decorative portions. A bend angle may be approximated by forming a beveled edge using a compound bend in which a second decorative portion is rotated to form an obtuse angle relative to a first decorative portion. A third decorative portion may be rotated relative to the second and/or first decorative portions, such that the third decorative portion is at an obtuse angle relative to the second decorative portion and at about a right angle relative to the first decorative portion.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, nor drawn to scale for all embodiments, various embodiments will be described and explained with additional specificity and detail through the use of the accompanying drawings in which:

FIG. 1 illustrates an example environment where some embodiments may be practiced;

FIG. 2 illustrates an enlarged cross-sectional view of decorative trim according to one aspect of the present invention;

FIGS. 3A-3D illustrate an exemplary method for bending a panel of decorative material into a desired decorative trim; and

FIGS. 4A-4J illustrate side views of various exemplary decorative trim panel styles that may be produced according to embodiments of the present invention.

### DETAILED DESCRIPTION

Some embodiments described herein are directed to a decorative planar material. For example, a decorative planar material may at least partially include a laminate material such as the plastic laminates sold under the Formica® or Wilsonart® brands, but may include other laminate materials. An exemplary decorative planar material may be used for a countertop, bathtub and shower surround, window, cabinet doors, cabinet drawer facings, flooring, or other application. Some embodiments described herein are also directed to a decorative trim panel made from a decorative planar material.

Exemplary embodiments relate to a decorative trim panel that may include a laminate material that has been contoured, bent, folded, or otherwise manipulated to form an edge, overhang, lip, bullnose, or the like. The laminate material in the decorative trim panel may be relatively brittle, such that it breaks at relatively small curve radii, and a decorative trim element may include laminate material that has been manipulated to bend at a radius smaller than the minimum allowable bend radii. Such a decorative trim panel may include features that allow the decorative trim panel to be used as boundary trim or molding.

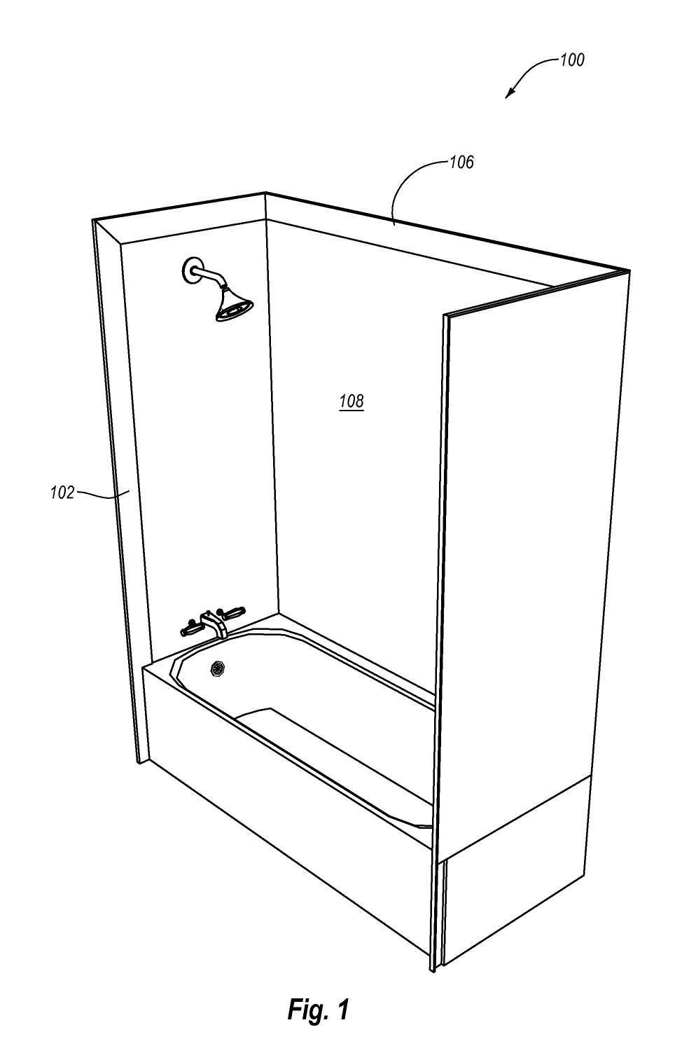

Referring now to FIG. 1, a more detailed example is illustrated. FIG. 1 illustrates an exemplary environment 100 in which a decorative trim panel 102 may be used in accordance with aspects of the present invention. In the illustrated embodiment, the environment 100 includes a bathtub 104 with a corresponding bathtub surround 106. The bathtub surround 106 may be formed from any suitable material, and may include tile, stone, laminate materials, or the like.

In one embodiment, the bathtub surround 106 is includes a laminate material 108 that is optionally a solid-surface laminate and/or plastic laminate. Such a laminate material 108 of the surround 106 may extend around all or a portion of the bathtub 104. In some embodiments, the laminate material 108 is substantially non-porous surface or otherwise guards against moisture penetration. The surround 106 may extend towards a proximal edge of the bathtub, adjacent to which the surround 106 may have an exposed edge of the laminate material 108. In some embodiments, the exposed edge of the surround 106 may be covered or otherwise obscured by one or more of the decorative trim panels 102, examples of which are described herein.

While the environment 100 generally illustrates a bathroom environment in which the laminate material 108 and the decorative trim panel 102 may be used in combination with a bathtub surround 106, it should be appreciated that this is merely exemplary and that laminate material 108 and/or the decorative trim panel 102 may be used in any number of different environments, and that exemplary environments may include any number of different features. For example, the environment 100 may be within a high-moisture area, and the decorative trim panel 102 and/or the laminate material 108 may be used in other moisture sensitive applications, such as in for a countertop around a bathroom or kitchen. In other embodiments, the decorative trim panel 102 and/or the laminate material 108 may be used in a generally dry environment, such as in connection with cabinetry.

The surround 106 may also be made of the same or a different material as the decorative trim panel 102. For example, in one embodiment, the surround 106 is made of tile, stone, or another material, while the decorative trim panel 102 is at least partially made from a laminate material or some other material. In some embodiments, the decorative trim panel 102 may simulate all or some of the material in the surround 106. In other embodiments, the surround 106 may be made of a laminate material 108, while the decorative trim panel 102 may also include a laminate material 108 therein. In some cases, the decorative trim panel 102 includes the laminate material 108 as a portion thereof.

In the embodiment illustrated in FIG. 1, a single decorative trim panel 102 may be placed along a surface or edge of the surround 106. For instance, in the illustrated embodiment, the decorative trim panel 102 extends approximately a full length of the left side of the surround 106, and may extend approximately the full height of the surround 106. In some embodiments, similar trim panels 102 may extend around or along more than one side of the surround 106, along or around a top surface of the surround 106, or the like. It should be appreciated, however, that this embodiment is merely exemplary, and provides one example in which the decorative trim panels 102 may be used. A decorative trim panel 102 according to the present disclosure may be made or fashioned into virtually any size. Thus, in other embodiments, more or fewer decorative trim panels 102 may be placed along a boundary. For instance, in some embodiments, multiple trim panels may have a lesser length and be combined to extend around a single edge or length of the surround 106, similar to installation of marble or cultured marble.

Furthermore, in this particular embodiment, the decorative trim panel 102 is aligned along a wall or other surface on which the surround 106 is mounted, and overlaps the laminate material 108. For instance, the decorative trim panel 102 may have an overhang or lip configuration that provides a finished boundary edge for the surround. In other embodiments, however, the decorative trim panels 102 may have other styles or configurations. For instance, the decorative trim panels 102 may have a bullnose configuration and can, for example, be butted against an exposed edge of the laminate material 108. In other embodiments, a lip may extend at least partially around a corner of a wall, along a window sill, or around a door, although other features may also be included on the decorative trim panel 102.

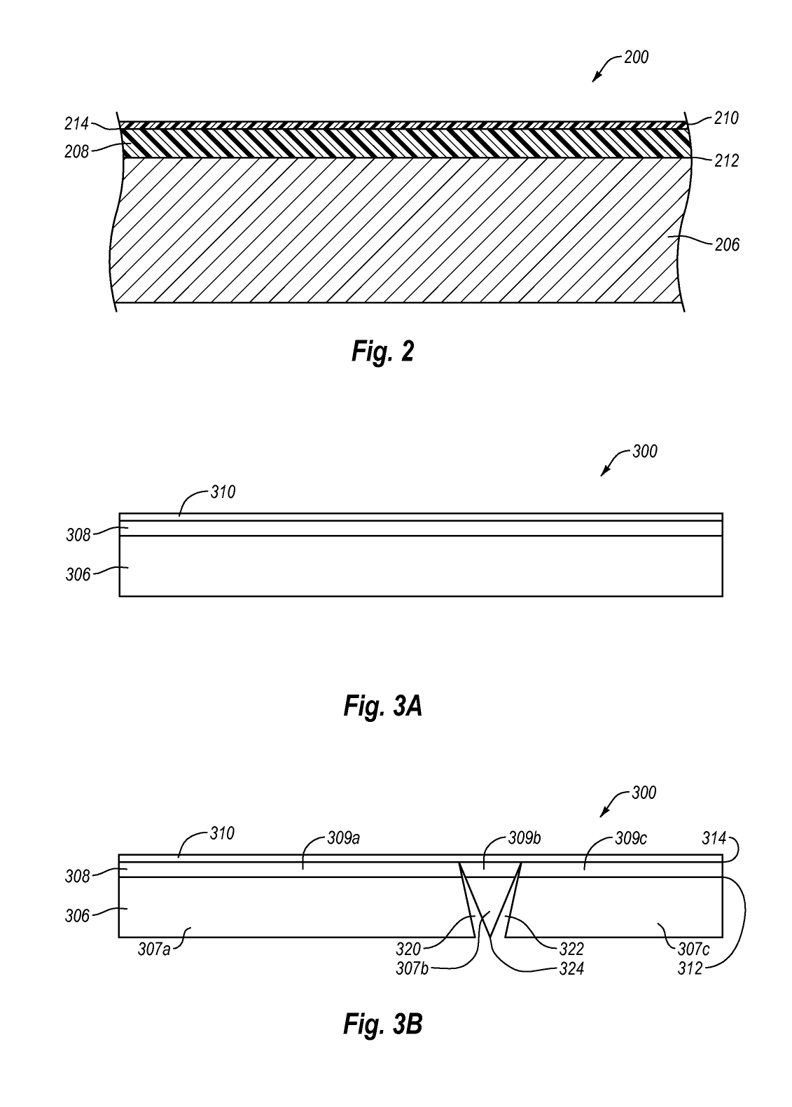

Referring now to FIG. 2, a decorative planar material that may be used in connection with embodiments of the present disclosure is described in additional detail. FIG. 2, for example, provides an enlarged cross-sectional view of an exemplary decorative planar material 200. In some embodiments, the decorative planar material 200 may be formed in sheets, with each sheet being made of a plurality of different layers, although other configurations are possible. The decorative planar material 200 in FIG. 1 may include, for instance, three layers 206, 208, 210, although in other embodiments, more or fewer layers may be included.

In the particular embodiment in FIG. 2, the decorative planar material 200 includes a substrate layer 206. Substrate layer 206 may provide any number functions and, in one embodiment, acts at least partially as a base for a decorative layer 208. For example, the thickness of the decorative layer 208 may be relatively small in some embodiments, when compared to a thickness of the substrate layer 206. The substrate layer 206 may have a greater thickness and/or be sufficiently rigid that when the laminate layer 208 is attached thereto, the decorative planar material 200 may be easily and efficiently handled or formed.

The substrate layer 206 may take any of a number of different forms. For example, in one embodiment, the substrate layer 206 may be a polymeric material such as foam, polyvinyl-chloride (PVC), high-density polyethylene (HDPE), or some other polymeric material, or a combination thereof. Polymeric materials may be desirable for a number of different reasons. For instance, polymeric materials may have relatively high strength-to-weight ratios. As a result, the substrate layer 206 may provide strength to the decorative planar material 206, while allowing the decorative planar material 200 to remain relatively lightweight. Of course, polymeric materials may be desirable for any number of other reasons, such as a relatively low manufacturing, handing and/or transportation cost, ease of manufacturing, bonding properties, moisture resistance, deformability, or other features or a combination thereof.

Notwithstanding such benefits of polymeric materials, other types of materials may also be used for the substrate layer 206 of the decorative planar material 200. For instance, in some embodiments, the substrate layer 206 may be made of metals, alloys, composites (e.g., glass or carbon-based), natural materials (e.g., stone, wood), and/or a variety of other types of materials.

As noted previously, a decorative layer 208 may also be included within the decorative planar material 200. In the embodiment illustrated in FIG. 2, for instance, the decorative planar material 200 is adjacent the substrate layer 206. In other embodiments, however, there may be one or more layers between the substrate layer 206 and the decorative layer 208, or there may be multiple substrate layers 206.

In some embodiments, the decorative layer 208 may be a laminate layer. For instance, the decorative layer 208 may include a plastic laminate material (e.g., materials branded under the Formica®, Wilsonart®, or other brands) that is generally used to provide the decorative or aesthetic impact of the decorative planar material 200. The decorative layer 208 may thus include a plastic laminate or other material that has one or more particular colors, patterns, textures, or other features, or a combination thereof. The decorative layer 208 of the present disclosure thus need not take any particular form or have any particular design or decorative impact, and even a laminate or other material that includes, for example, a solid color may be used for the decorative layer 208. For instance, the desired decorative impact for a countertop, bathtub surround, or other location may include a single color with little or no variation, in which case the decorative layer 208 may provide a laminate or other material of such color and provide the desired decorative appeal.

The decorative layer 208 may provide a decorative feature on any suitable surface. For instance, in this embodiment, the decorative layer 208 may have decorative features visible on a lower surface 212 and/or an upper surface 214. In some cases, the decorative features or aspects of the decorative layer 208 may not extend fully through the laminate or other material of the decorative layer 208. For instance, the substrate layer 206 may be substantially non-transparent, such that it would prevent a view of the lower surface 212 of the decorative layer 208. In such a case, the lower surface 212 optionally does not include a desired decorative feature, and a decorative feature may instead be visible only from the upper surface 214, although it should be appreciated in view of the disclosure herein that the opposite may also be true.

In some embodiments, the decorative layer 208 may be formed from a laminate material that itself includes multiple layers to provide the desired decorative appeal, and such that the decorative aspects of the laminate material are primarily provided on a single surface. Other layers may also be provided within the laminate material to provide the strength, appearance, moisture-resistance, or other features, or a combination thereof, for the laminate material. Such a laminate may be produced by a manufacturer and thereafter combined with the substrate layer 206 and coating layer 210 of FIG. 2, and/or may be included in the decorative planar material 200 of FIG. 2 as an after-market product.

Where the decorative layer 208 is a laminate material that includes multiple layers, one or both of the substrate layer 206 and the coating layer 210 may be attached to the decorative layer 208 as part of the process of forming the decorative layer 208; however, this is merely optional. In other embodiments, the coating layer 210 and/or the substrate layer 206 may be formed independent of the laminate or other material of the decorative layer 208, and thereafter combined to form the decorative planar material 200 of FIG. 2. For instance, the coating layer 210 may be applied after a laminate material of the decorative layer 208 has been fully formed (e.g., where the decorative layer 208 is combined in as an after-market product or with a laminate product that may also be used without combination into the decorative planar material 200). Accordingly, in one embodiment, the decorative layer 208 may be pre-manufactured and secondarily combined with the substrate layer 206 and/or the coating layer 210.

According to the illustrated embodiment, the coating layer 210 may be adjacent to the top surface 214 of the decorative layer 208. In some embodiments, such as where the upper surface 214 of the decorative layer 208 includes desired visual or other decorative features, the coating layer 210 may be transparent or substantially transparent. As a result, the coating layer 210 may be placed on the top surface of the decorative layer 208 while allowing the decorative planar material 200 to maintain substantially its full desired decorative impact.

The coating layer 210 may serve a number of different purposes. As disclosed herein, for instance, the coating layer 210 may be formed of a flexible material that can bend at tighter radii than the decorative layer 208. Thus, if the decorative planar material 200 is bent to form a desired shape, the coating layer 210 may stretch and/or bend to accommodate bends even at tight radii, while remaining substantially integral in form. Accordingly, if the decorative layer 208 is broken, cut, or separated, the coating layer 210 may also act as a bonding layer that maintains the pieces of the decorative layer 208 at least indirectly connected by maintaining integral at least adjacent the breaks or separations between portions of the decorative layer.

The coating layer 210 may also provide a substantially moisture resistant seal for the decorative planar material 200. In some embodiments, such as where the decorative layer 208 includes a non-porous laminate material, the sealing aspect of the coating layer 210 may be eliminated, although both the decorative layer 208 and the coating layer 210 may be substantially non-porous and/or moisture resistant in other embodiments. For instance, even where the decorative layer 208 is moisture resistant, it may be beneficial to have a moisture resistant coating layer 210 to substantially seal the decorative planar material 200 at separations between portions of the decorative layer 208. Separations in the decorative layer 208 may occur intentionally as described herein, or may be inadvertent.

The particular material used to produce the coating layer 210 may be varied according to the circumstances and embodiments. For instance, in some embodiments, the decorative planar material 200 may be in a high-use area and a wear resistant material may be used, or in a heat-sensitive application such that the coating layer 210 is chosen to be heat resistant. In other embodiments, the decorative planar material 200 may be subjected to many or small radii bends, such that a very flexible material is desired. Of course, the material used for the coating layer 210 may be chosen based on additional or other considerations as well. According to some example embodiment, the coating layer 210 is a film applied to the decorative layer 208 after production of the decorative layer 208 has been completed. The coating layer may be composed of polymeric materials such as films made from polycarbonate, polyvinyl, polystyrene, polymethyl metacrylate, polymethylpentene, polypropylene, other polymeric materials, or combinations thereof. In other embodiments, other natural, composite, metallic, alloy, or other materials or films may be used in the coating layer 210.

In the example embodiment illustrated in FIG. 2, each of the layers 206, 208, 210 may be directly attached to adjacent layers. Accordingly, in one embodiment, the substrate layer 206 may be connected to the lower surface 212 of the decorative layer 208, while the upper surface 214 of the decorative layer 208 may be connected directly to the coating layer 210. This is merely exemplary, however, and there may be one or more intervening layers between the substrate layer 206 and the decorative layer 208 and/or between the decorative layer 208 and the coating layer 210, or other layers may be substituted.

Any type of mechanism may also be used to connect the layers 206, 208, 210. For instance, in one embodiment, one or more of the layers 206, 208, 210 may be attached to an adjacent layer using an adhesive. For instance, an epoxy, anaerobic, cyanocrylate, acrylic, polyurethane, silicone, phenolic, polyimide, hot melt, platisol, polyvinyl acetate, pressure-sensitive, or other type of adhesive may be used. In other embodiments, an ionization or heat bonding processes may be used to bond together adjacent layers within the decorative planar material 200. In still other embodiments, mechanical fasteners (e.g., staple, rivet) may be used to connect one or more of the layers 206, 208, 210 together.

According to some embodiments, the layers 206, 208, 210 may be attached in a manner that is configured to facilitate thermal expansion of the decorative planar material 200. For instance, the decorative planar material 200 may be exposed to heat or cold, thereby resulting in thermal expansion or contraction within the layers 206, 208, 210. An adhesive or mechanical fastener may be used or chosen based on a thermal expansion coefficient generally corresponding to one or more of the layers 206, 208, 210. The layers 206, 208, 210 may also use materials intended to take into account rates and extents of expansion under thermal conditions. Of course, in some embodiments, the decorative planar material 200 may be made of materials where thermal expansion is minor and/or not significant for a particular application, such that thermal expansion between the layers 206, 208, 210 and/or fastening mechanisms can be ignored or only be a minor consideration.

In some embodiments, the layers 206, 208, 210 may be attached together with an adhesive, bonding process, mechanical fastener, or by some other attachment means that provides a permanent attachment between two or more of the layers 206, 208, 210. As used herein, “permanent” or “permanent attachment” may be used to designate an attachment between two materials, layers, components, or the like in a manner that is not removed following installation of a decorative planar material 200 and/or that is not intended to be removed following installation of a decorative planar material 200. For instance, a trim or molding panel formed from the decorative planar material 200 may be installed as a boundary or trim panel, and may include a coating layer 210 that is permanently attached to the decorative layer 208. The coating layer 210 may remain on the decorative layer 208 after installation of the trim or molding panel, and may be intended to remain for an indefinite period of time. Installation of the decorative trim or molding may be accomplished without requiring and/or benefiting from the removal of the coating layer 210 from the decorative layer 208. For instance, the coating layer 210 may provide a finished appearance without machining or grinding the surface of the decorative layer 208. While the coating layer 210 may wear or peel off over time, such removal does not negate the permanent attachment therebetween, regardless of whether such removal causes damage to the underlying decorative layer 208 or not.

According to some embodiments, a permanent attachment between two or more of the layers 206, 208, 210 may facilitate installation and use of the decorative planar material 200. For instance, as described in greater detail herein, the substrate layer 206 and/or the decorative layer 208 may be cut, broken, or otherwise separated into multiple pieces while a portion of the coating layer 210 adjacent the separation in the decorative layer 208 may remain intact. As a result, the decorative layer 208 may be bent around a radius that is much tighter than otherwise allowed for one or more materials within the decorative layer 208. For instance, a plastic laminate material that has a minimum bend radius of four inches, could be broken at a particular location and then bent to approximate a bend radius of a quarter-inch or less. Moreover, by maintaining the integral nature of the coating layer 210, the coating layer 210 can remain attached to the different portions or pieces of the decorative layer 208, thereby holding them together and maintaining their positions relative to each other. In other words, the coating layer 210 can connect different pieces of the decorative layer 208 and stretch or bend to allow the decorative planar material 200 to bend, or approximate a bend, over even very small radii. For instance, even for a laminate material that forms all or a portion of the decorative layer 208, very tight radii can be formed or approximated and maintained using the coating layer 210, without the need to remove a coating and/or machine or grind the surfaces of the laminate material to form the tight radii. In effect, a bend radius can be achieved based on the flexibility of the coating layer 210 rather than based on the flexibility of the decorative layer 208.

With continued reference to FIG. 2, it will be appreciated that the layers 206, 208, 210 are illustrated as having varying thicknesses, although in view of the disclosure herein, it will be appreciated that the illustrated thicknesses are merely exemplary. For instance, in FIG. 2, the decorative layer 208 has may have a thickness that is approximately one-fifth the thickness of the substrate layer 206. In other embodiments, the thickness of the decorative layer 208 is larger or smaller relative to the thickness of the substrate layer 206. For instance, the thickness of the decorative layer 208 is, in some embodiments, between ten and thirty percent the thickness of the substrate layer 206, although the thickness may be greater than thirty percent or less than ten percent the thickness of the substrate layer 206.

In the illustrated embodiment, the thickness of the coating layer 210 is approximately one-quarter the thickness of the decorative layer 208. This too is merely exemplary, and in some embodiments, the coating layer 210 may be between ten percent and two-hundred percent the thickness of the decorative layer 208, but even greater or lesser thickness ratios may be used. The overall thickness of the decorative planar material 200 may also vary. For instance, the thickness of the decorative planar material 200 may vary from between about 0.15 inch to about one inch. In other embodiments, however, the decorative planar material 200 may have a thickness greater than one inch or less than 0.15 inch.

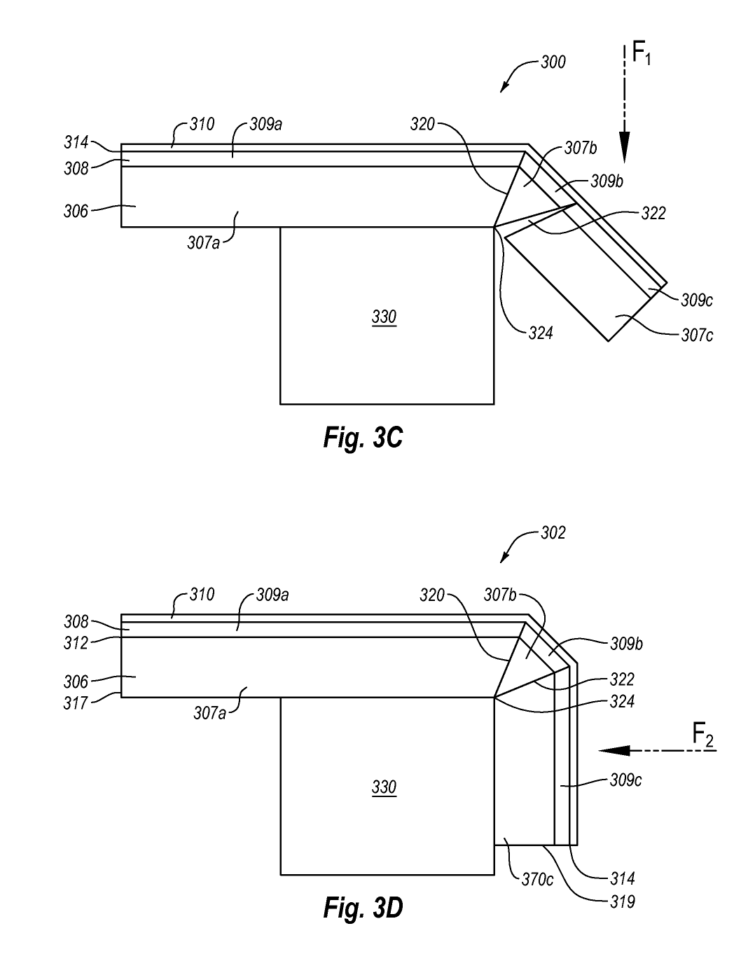

Turning now to FIGS. 3A-3D, various steps of an exemplary method are illustrated. The illustrated method may include bending or otherwise forming a decorative planar member 300 into a decorative trim panel 302. The illustrated method may be fully or partially practiced in an environment where installation of the decorative trim panel 302 is to occur. Additionally, or alternatively, some or all of the steps of the method may be practiced outside the installation environment, such as where the decorative trim panel 302 is pre-manufactured for custom installation or with standard sizes, shapes, configurations, lengths, or other features, or a combination thereof.

In the exemplary method, a decorative planar member 300 may be provided or produced. The decorative planar member 300 may be similar to any of the decorative planar members or decorative trim panels described herein. For instance, in FIG. 3A, the decorative planar member 300 includes three layers 306, 308, 310. The different layers in the illustrated embodiment may correspond to a substrate layer 306, decorative layer 308, and/or coating layer 310, although additional or other types of layers may also be provided. In some embodiments, the decorative layer 308 at least partially includes a laminate material such as plastic laminate exemplified by Formica® branded products, and/or has decorative features that are visible through the coating layer 310.

The decorative planar member 300 may be transformed into a decorative trim panel 302 by using any of a variety of different processes. According to one embodiment, the decorative planar member 300 has one or more cuts or incisions 320, 322 formed therein to facilitate transforming the decorative planar member 300 into a decorative trim panel 302. For instance, in FIG. 3B, the decorative trim panel 300 includes two angled cuts 320, 322. The number, position, shape, size, or other configuration of the cuts may be varied as desired or necessary to achieve a particular appearance or configuration of the decorative trim panel 302. By way of illustration, the two cuts 320, 322 in FIG. 3B originate from a common point 324 at the base of the substrate layer 306, and angle towards the decorative layer 308. The angled cuts 320, 322 are offset by approximately forty-five degrees, so as to diverge as the cuts 320, 322 approach the decorative layer 308. In embodiments in which the angled cuts 320, 322 extend fully through the substrate layer 306, the cuts 320, 322 may separate the substrate layer 306 into three portions. In the illustrated embodiment, for instance, the substrate layer 306 is separated into a first portion 307a bounded by a vertical edge of the substrate layer and the first angled cut 320, a second portion 307b bounded by the angled cuts 320, 322, and a third portion 307c that is bounded by a vertical edge of the substrate layer and the second angled cut 322.

In some embodiments, the cuts 320, 322 may form a second portion 307b that has a generally triangular configuration, such as is illustrated in FIG. 3B. It should be appreciated, however, that this is merely exemplary. For instance, in other embodiments, the cuts 320, 322 may not originate from a common point 324, and a trapezoidal or other shaped portion may be produced. In still another embodiment, the cuts 320, 322 may extend along a common path through a portion of the substrate layer 320 and thereafter diverge. Thus, in some embodiments, the second portion 307b of the substrate layer 306 may have a thickness that is less than the thickness of the substrate layer 306. Any number of different types of cuts or separations may be used to produce, for example, straight, angled, dovetail, or other features, or a combination thereof.

As also illustrated in FIG. 3B, the cuts 320, 322 optionally extend through the substrate layer 306 and into the decorative layer 308. In some embodiments, the cuts 320, 322 may extend partially into the decorative layer 308 to create a notch in the decorative layer 308, while in other embodiments, one or both of the cuts 320, 322 may extend fully through the decorative layer 308 (e.g., from lower surface 312 to upper surface 314).

The cuts 320, 322 may be produced in any suitable manner. For instance, in some embodiments, the cuts 320, 322 may be produced by using a rotary saw, although other types of machinery may be used. For instance, the cuts 320, 322 may be produced by using some other type of saw, a mill, grinder, or another type of machinery or equipment. In one embodiment, a V-Groover such as those available from Star “V” Machinery may be used to produce the cuts 320, 322. In still other embodiments, the cuts 320, 322 may be performed by, for example, forming the substrate layer 306 and/or the laminate layer 308 in separate pieces and then joining them to form the cuts 320, 322.

The shape of the cuts 320, 322 may also be varied. For instance, in the illustrated embodiment, the cuts 320, 322 each have a generally triangular shape. In other embodiments, however, the shape may be generally rectangular, such as where a rotary saw cuts a single slice into the decorative planar material 300 to form the cuts 320, 322. The size of the cuts 320, 322 may also be varied. By way of illustration, the width of the cuts 320, 322 may vary based on various considerations, including the thickness of a saw blade, milling tool, or other device used in making the cuts 320, 322. In other embodiments, the size of the cuts 320, 322 may be varied to, for example, reduce or eliminate interference between the substrate portions 307a-c as the decorative planar material 300 is bent, formed, or manipulated.

The cuts 320, 322 are thus one element of the illustrated process that may be varied. For instance, in some embodiments, two cuts 320, 322 are formed to provide a compound bend that results in a right angle. In other embodiments, there may be a single cut. For instance, a single cut may be used to create a bend at about a forty-five degree angle. In still other embodiments, more cuts may be made. For instance, there may be different sets of cuts on the same or different ends, so that different portions of the decorative planar material 300 may be folded or bent to form multiple bends, angles, curves, or a combination thereof.

As illustrated in FIG. 3B, some embodiments contemplated herein consider making cuts 320, 322 that extend through the substrate layer 306 and the decorative layer 308, but which do not extend through the coating layer 310, or which do not extend sufficiently into the coating layer 310 to cause the coating layer 310 to separate into distinct portions. The cuts 320, 322 in this embodiment, for instance, end at approximately the upper surface 314 of the decorative layer and do not extend, or do not significantly extend, into the coating layer 310. Thus, in some embodiments, the coating layer 310 may remain integral and in a single portion along an entire length of the coating layer 310. In other embodiments, there may be multiple portions of the coating layer, while a portion of the coating layer 310 directly adjacent the cuts 320, 322 may remain integral.

Turning now to FIG. 3C, another exemplary step in a process for creating a decorative trim panel 302 from a decorative planar material 300 is illustrated. In this example, the decorative planar material 300 is bent around the first cut 300. More particular, in FIG. 3C, an optional guide 330 may be placed proximate to the substrate layer 330 and a force F₁ may be applied. The force F₁ may be applied and/or directed in a manner that causes the second and/or third substrate portions 307b, 307c and/or second and/or third decorative layers 309b, 309c to rotate or otherwise move relative to the first substrate portion 307a and/or the first decorative portion 309a. In FIG. 3C, for instance, the force F₁ causes the substrate portions 307b, 307c and the decorative portions 309b, 309c to rotate clockwise relative to the first substrate portion 307a and first decorative portion 309a. The clockwise rotation in this embodiment is about forty-five degrees, although the rotation or other movement may be to a greater or lesser extent.

As the illustrated second portions 307b, 309b rotate relative to the portions 307a, 309a, the lower surfaces of the portions 307a, 307b, 309a, 309b may draw together. For instance, the common point 324 on the second substrate portion 307b may be drawn towards a lower surface of the first substrate portion 307a, which can also cause the corresponding edges of the substrate portions 307a, 307b to draw towards each other. In some embodiments, the resulting angle between the first and second substrate portions 307a, 307b is based on the shapes and/or sizes of the cuts 320, 322. For instance, if the cuts 320, 322 are isosceles triangles with a forty-five degree angle between equal sides, the second substrate portion 307b may bend about forty-five degrees relative to the first substrate portion 307a before contacting the edge surface of the first substrate portion 307a. In other embodiments, however, the shape and/or size of the cuts 320, 322 may have little or no impact on the resulting angle. For instance, the substrate layer 306 may be formed, in some embodiments, from a deformable material. As the second substrate portion 307b rotates relative to the first substrate portion 307a, there may be interference that causes the first and/or second substrate portions 307a, 307b to deform. Thus, a forty-five degree angle, or some other angle, between the first and second substrate portions 307a, 307b could be formed despite deformation and/or interference between the bent first or second substrate portion 307a, 307b.

Although the illustrated embodiment illustrates the cuts 320, 322 extending fully through the decorative layer 308 such that rotation of the decorative portions 309b, 309c may be accomplished, it should be appreciated that this is merely exemplary. In some embodiments, for instance, the cuts 320, 322 may extend only through the substrate layer 306 and/or only partially into the decorative layer 308. In such case, the movement of the decorative portions 309b, 309c relative to the first decorative portion 309a may cause the decorative layer to break and extend the length of the cuts 320, 322.

While the separate portions of the substrate layer 306 and/or the decorative layer 308 may thus move relative to each other and/or be separated (e.g., by cuts 320, 322) to facilitate such relative motion, the coating layer 310 may remain integral in some embodiments. In FIG. 3C, for instance, the coating layer 310 may be composed at least partially from a flexible material. As the second portions 307b, 309b are rotated, the coating layer 310 may bend proximate the first cut 320. The coating layer 310 may thus hold the decorative layer 308 together and allow the first and second decorative portions 309a, 309b to remain in or near contact, despite being physically separate.

Turning now to FIG. 3D, another example step is illustrated and is representative of one or more steps that may be used in a method for producing a decorative trim panel 302 from a decorative planar material 300. In the illustrated embodiment, a force F₂ may be applied to the decorative planar material 300. The application of the force F₂ may cause at least the third portions 307c, 309c to rotate relative to the first portions 307a, 309a and/or relative to the second portions 307b, 309b. In this embodiment, for instance, the force F₂ causes the third substrate portion 307c and the third decorative portion 309b to have an additional clockwise rotation relative to the first substrate portion 307a and first decorative portion 309a, thereby producing, in this embodiment, a beveled edge. In particular, the illustrated embodiment depicts a movement of the third portions 307c, 309c such that the third portions 307c, 309c are approximately rotated an additional forty-five degrees to form a beveled edge generally defined along the upper surface of the second decorative portion 309b, and such that the first and third substrate portions 307a, 307c approximate a right angle.

When the decorative trim panel 302 is formed in the manner illustrated in FIG. 3D, or in any other suitable manner, the various portions of the layers 306, 308, 310 may thus be offset at various angles. For instance, in the illustrated embodiment, obtuse angles may be formed between the second decorative portion 309b and each of the first and third decorative portions 309a, 309c. The substrate layer 306 may also have a corresponding configuration. The angles themselves may vary. For instance, in this particular embodiment, the second decorative portion 309b may form approximately a one-hundred thirty-five degree angle relative to each of the first and third decorative portions 309a, 309c, such that the first and third decorative portions 309a, 309c are offset at approximately a ninety degree angle. In other embodiments, there may be greater or lesser angles, and in some cases, different angles may be defined between the second decorative portion 309b and the first and third laminate portions 309a, 309c, respectively.

As illustrated in FIG. 3D, when the portions of the decorative layer 308 are bent or otherwise moved or rotated, the coating layer 310 may remain intact and may particularly continue to have an integral construction adjacent the cuts 320, 322 that are may facilitate creation of features in the decorative layer 308 and/or the substrate layer 306. For instance, the coating layer 310 may be made of a flexible material that flexes, bends, stretches, elastically deforms, plastically deforms, or otherwise accommodates movement and/or rotation between the different portions of the decorative layer 308. By maintaining an integral construction in the coating layer 310, the different decorative portions 309a-c and/or substrate portions 307a-c may be held together, despite being physically separate. In particular, the coating layer 310 may act as a bonding layer that holds the substrate layer 306 and/or the decorative layer 308 at a desired location or orientation, and/or holds the decorative planar material 300 together even when one or more layers have been separated into multiple portions.

In some embodiments, the layers 306, 308, 310 are bent by applying heat. For instance, heat may be applied to increase the flexibility of the coating layer 310 and facilitate bending of the entire decorative trim panel. Heat may be applied in any number of manners. For example, a hot wire or strip heater may be used to apply heat to the decorative planar material 300 to facilitate bending. In other embodiments, the layers 306, 308, 310 may be cold bent. Regardless of the manner in which the decorative trim panel is bent, a weld may optionally be used to hold the materials in the bent configuration. For instance, a polyvinyl chloride (PVC) weld may be used, although other types of welds, fasteners, or other structures may optionally hold the decorative trim panel in the bent configuration.

In some embodiments, the coating layer 310 may also provide a waterproof seal at the separation between the decorative portions 309a-c. For instance, the decorative layer 308 may be formed of a substantially non-porous material; however, the cuts 320, 322 may create openings that would allow moisture to penetrate the decorative layer 308. The coating layer 310 may thus also act as a sealant for the decorative layer 308, even when the decorative layer 308 is substantially non-porous or is otherwise resistant to moisture penetration.

According to some embodiments, the decorative layer 308 includes a material that is brittle or is otherwise difficult or impossible to bend at tight radii without either breaking the material or machining the upper surface of the material. The decorative trim panel 300 illustrates an example embodiment in which tight radii may be accommodated by purposely cutting or breaking the decorative material, and then providing a finished edge that approximates a bend. For instance, the most flexible Formica® branded laminate materials may have a minimum bend radius of about four inches when heated. In an example embodiment, the total thickness of the decorative planar material 300 in FIGS. 3A-3D may be about a quarter-inch. As shown in FIG. 3D, the decorative layer 308 may be bent to form a right angle, such that in the case of a quarter-inch thickness, even in the absence of heating the decorative layer, a bend radius of about a quarter-inch is approximated in the finished decorative trim panel 302. As will be appreciated in view of the disclosure herein, the thickness of the decorative planar material may be more or less than a quarter-inch, and such dimension is provided merely to illustrate one example in which a tight bend radius may be obtained with material that breaks at such a bend radius.

The coating layer 310 may also provide a finished edge on the decorative trim panel 302 for the broken, cut, or otherwise separated portions of the decorative layer 308. By way of illustration, the coating layer 310 can hold the different portions of the decorative layer 308 tightly together such that the boundary between the different portions (e.g., portions 309a, 309b, 309c) is difficult or impossible to identify, or which otherwise reduces separation between the different portions. Additionally, the coating layer 310 can be permanently applied to the decorative layer 308 such that the coating layer 310 provides the finished edge even in the absence of grinding or otherwise machining the outer surface of the decorative layer 308.

While FIGS. 3A-3D illustrate various example steps in producing a decorative trim panel 302 from a decorative planar material 300, it should be appreciated that the illustrated steps are merely exemplary, and that some steps may be omitted, added, or substituted. For instance, while the illustrated method includes cutting two angled cuts 320, 322, more or fewer cuts, or cuts of different sizes, shapes, or orientations may be made. Additionally or alternatively, the guide 330 used informing a right angle in the decorative trim panel 302 may be omitted, changed, or otherwise located. For instance, if an angle other than a right angle is desired, the guide 330 may have a different shape or location. In still another embodiment, a guide may be used adjacent an external surface of the coating layer 310 in addition to, or instead of, the guide 330 adjacent the substrate layer 306. It should thus be appreciated that a variety of different actions may be made to produce a decorative trim panel as contemplated in accordance with the present disclosure.

A desired method for producing a decorative trim panel may thus be dependent on a number of factors, including the types of materials used, the type of equipment available, the desired form of a finished decorative trim panel, or other considerations, or combinations thereof. For instance, in FIG. 3D, the produced decorative trim panel 302 may include exposed, visible ends. More particularly, the proximal edge 317 and/or the distal edge 319 may be exposed such that the different layers 306, 308, 310 are visible. Additional or alternative steps may be taken to cap or finish the proximal and/or distal edges 317, 319 so that a view along such edge provides a decorative appearance rather than a layered view. For instance, additional cuts similar to cuts 320, 322 may be made to create an additional angle thereby providing finished edges.

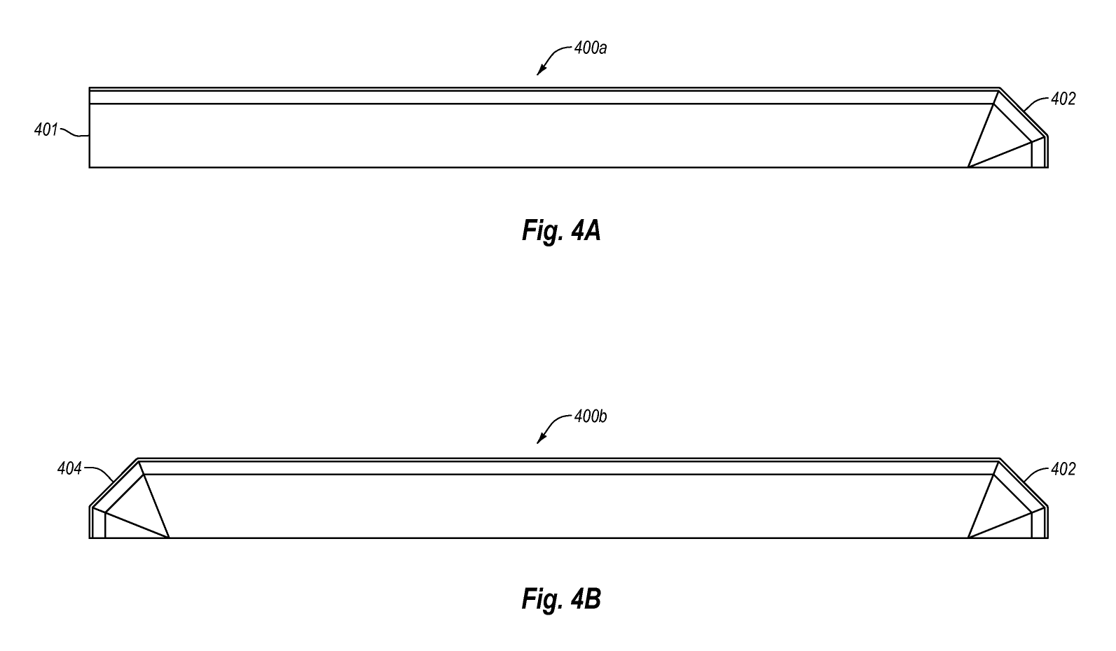

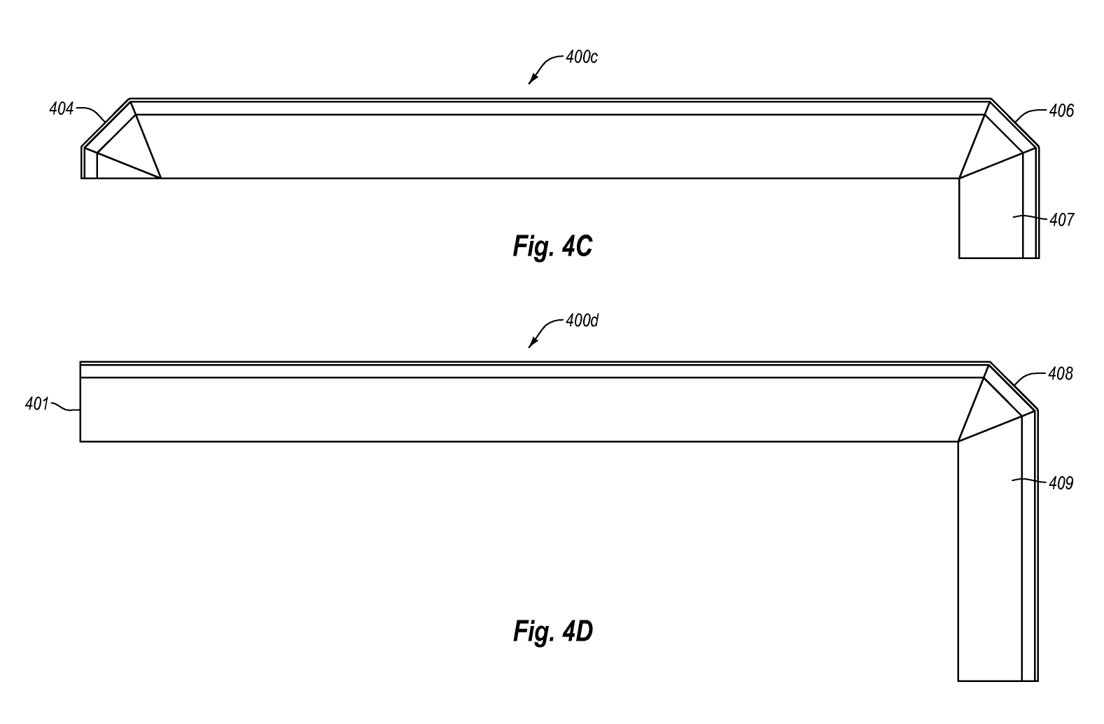

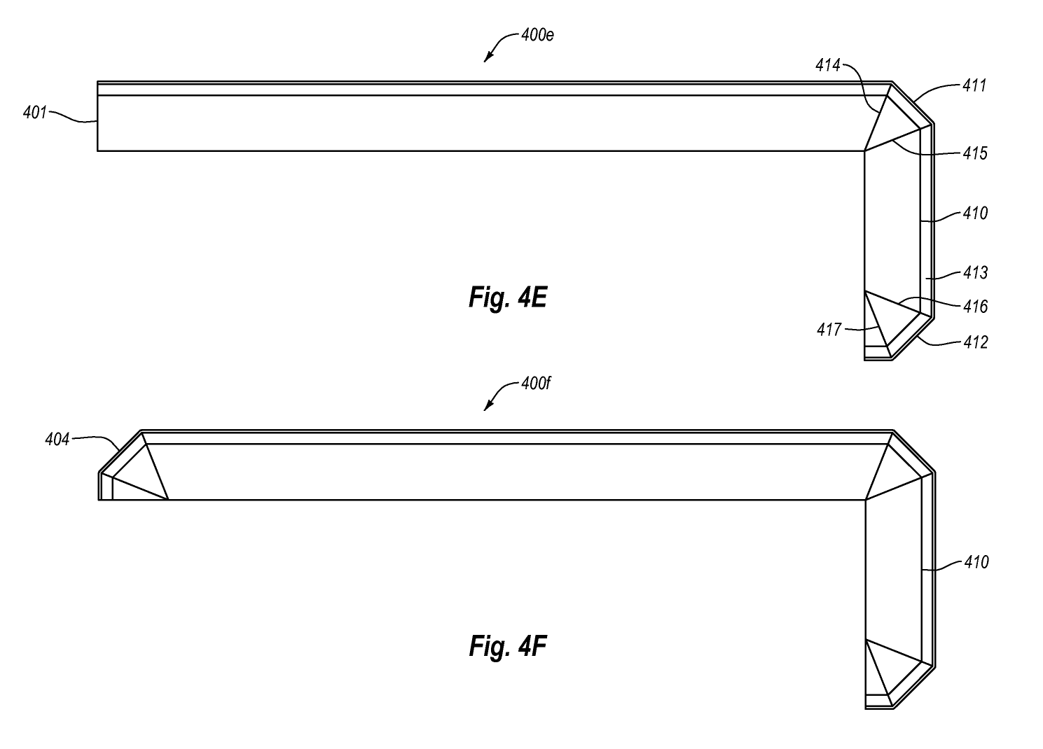

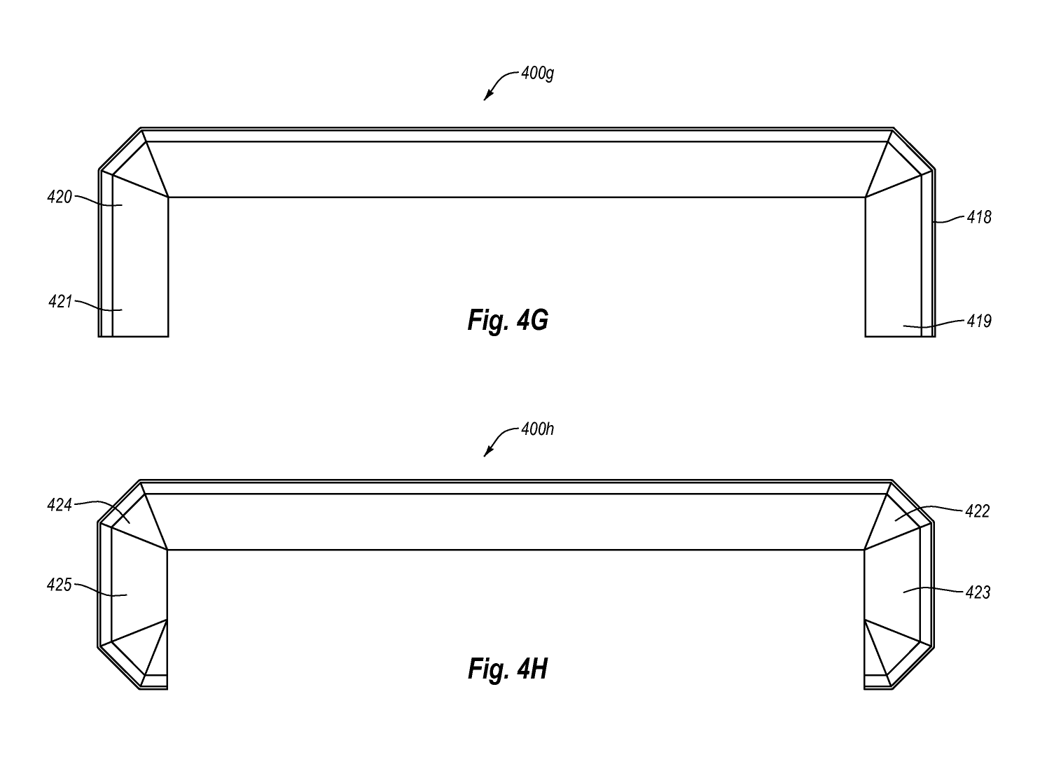

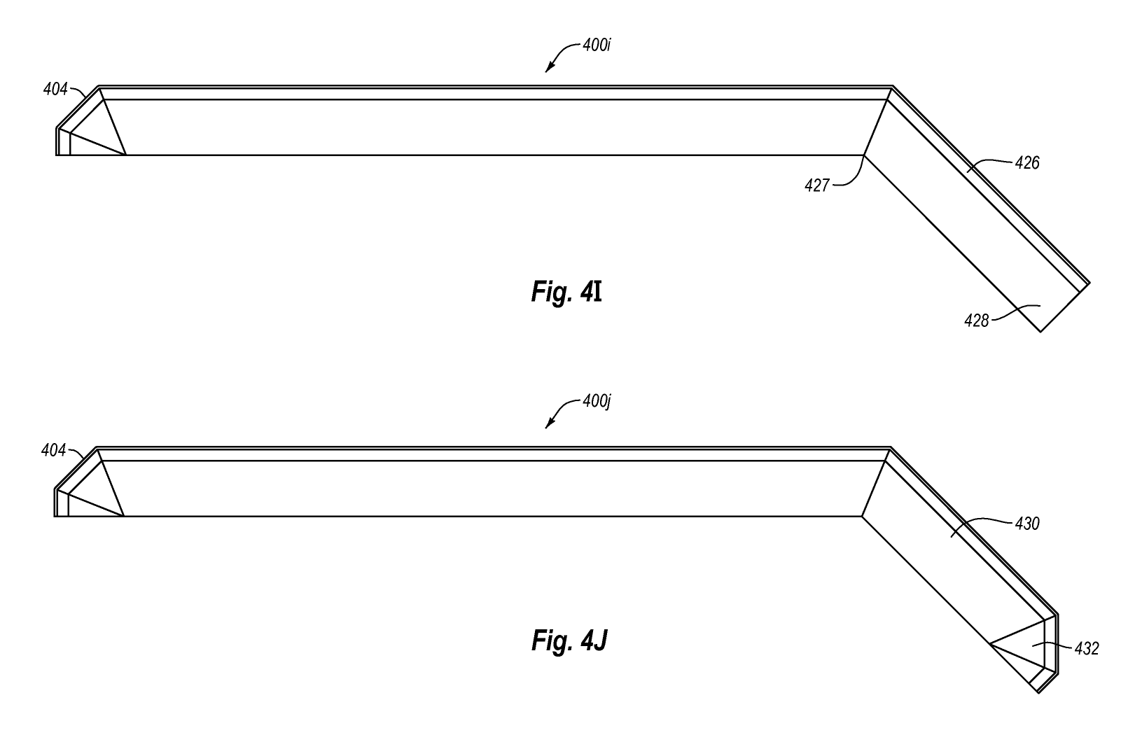

Turning to FIGS. 4A-4J, various examples of decorative trim panels that may be produced in accordance with the disclosure herein are described. As will be appreciated, the illustrated decorative trim panels are merely illustrative of a number of different types of panels or features that may be produced, but are not intended to provide an exhaustive list of all available panels or features. Indeed, different types or sizes of features may be combined to provide a limitless selection of decorative trim panels consistent with the disclosure herein.

FIGS. 4A-4J illustrate different types of decorative trim panels that include a variety of different features. FIG. 4A, for example, illustrates a decorative trim panel 400a that includes an exposed proximal edge 401, and finished distal edge end. In particular, in the illustrated embodiment, the finished distal end 402 may be formed in a manner similar to that described relative to FIGS. 3A-3D; however, the length of the third portions 307c, 309c (FIG. 3D) may be shortened such that a bullnose-type feature, rather than an overhang or lip feature, be formed. In other embodiments, the finished distal edge 402 may be formed by following the process in FIGS. 3A-3D, and then adding an additional step of cutting off the lip portion to form the bullnose feature of finished distal end 402.

FIG. 4B illustrates another example decorative trim panel 400b, and is similar to decorative trim panel 400a of FIG. 4A in that it also includes a finished distal end 402 having a bullnose type edge. Decorative trim panel 400b includes, however, a finished proximal end 404 that may also include a bullnose edge feature. Thus, the decorative trim panel 400b FIG. 4B may be generally symmetric, although symmetry is merely an optional feature and not required for any embodiment described herein.

The finished distal and proximal ends 402, 404 of FIGS. 4A and 4B may have heights generally corresponding to a thickness of the decorative trim panels 400a, 400b. Thus, for an example decorative trim panel similar to those in FIGS. 4A and 4B, a quarter-inch thick decorative planar material may be formed into a decorative trim panel that maintains a footprint size that is a quarter-inch thick. This is, however, merely an example and the finished distal or proximal ends may be lesser than or greater than the thickness of the decorative planar material, and the decorative planar material may have a thickness greater or lesser than a quarter-inch. For example, FIGS. 4C-4J illustrate additional examples of decorative trim panels 400c-400j in which the footprint height of a decorative trim panel exceeds the thickness of the decorative planar material used to produce the decorative trim panel.

In FIG. 4C, for instance, a decorative trim panel 400c includes a finished proximal end 404 similar to that described with respect to FIG. 4B, as well as a finished distal end is included 406. The finished distal end 406 of FIG. 4C may include, for example, a lip 407 that extends from the bend of the finished distal end 406. In particular, the lip 407 may extend beyond the thickness of the decorative planar material, such that the height of the footprint size of the decorative trim panel 400c is increased. The length of the lip 407 may vary. For instance, in one embodiment, the lip 407 may cause the height of the footprint size of the decorative trim panel 400 to be about twice the thickness of the decorative planar material, although in other embodiments, the height is more than double the thickness of the decorative planar material, or in other embodiments less than double the thickness of the decorative planar material.

A similar lip 409 is illustrated in FIG. 4D, such that the lip 409 of the finished distal end 408 causes the height of the decorative trim panel 400d to be about four times the thickness of the decorative planar material. In FIG. 4D, the decorative trim panel 400d includes an exposed proximal end 401, although in other embodiments, the exposed proximal end 401 may be replaced with a finished proximal end having any number of different configurations or features.

FIG. 4E illustrates another example of a decorative trim panel 400e according to aspects of the present invention, in which a finished distal end 410 includes a lip 413. In FIG. 4E, the finished distal end 410 is similar to finished distal end 408 in FIG. 4D, but includes a second finishing feature. More particular, finished distal end 410 of FIG. 4E includes first and second distal bends 411, 412. For instance, first distal bend 411 may include two cuts 414, 415 that facilitate bending or movement within one or more layers of the decorative trim panel 400e. The cuts 414, 415 may allow the first distal bend 411 to bend, for example, at a right angle.

In some embodiments, a finished distal end 410 may also include a second bend 412 that also includes one or more cuts 416, 417 to facilitate bending of one or more layers of the decorative trim panel 400e. In FIG. 4E, the second bend 412 includes two cuts 416, 417 that also facilitate bending of the lower portion of the lip 413 at a right angle, for instance. Thus, multiple cuts may be made to form a simple finished end, a compound finished end with multiple finishing features, a finished end with a lip portion, and/or a number of different features. Moreover, the multiple cuts may separate layers of the decorative trim panel 400e into multiple portions. For instance, the decorative trim panel 400e of FIG. 4E includes four cuts 414-417 that may separate various layers of the decorative trim panel 400e into five or more portions.

The multiple bends of the finished distal end 410 in FIG. 4E may provide a lip that also includes a finished appearance at an edge thereof. For instance, by viewing the distal edge of the lip 409 in FIG. 4D, one may be able to view one or more underlying materials that compose the decorative trim pane 400d, including any layers therein. The lip 413 in FIG. 4E, however, by virtue of the second bend, may have a distal edge that provides a decorative or other appearance (e.g., by exposing a decorative layer) instead of exposing underlying layers or materials.

FIG. 4F illustrates a decorative trim panel 400f that includes a finished distal end 410 similar to that described and illustrated with respect to the decorative trim panel 400e in FIG. 4E. In FIG. 4F, however, the decorative trim panel 400f includes a finished proximal end 404, which may be used, for example, to obscure underlying materials in the decorative trim panel 400e and expose a particular surface, decorative feature, or the like. In FIG. 4F, a series of cuts may be made as described herein, such that up to seven or more portions of layered materials may be produced to facilitate or accommodate bending of the decorative trim panel 400f at the distal and proximal ends.

Now referring to FIGS. 4G and 4H, additional exemplary embodiments of decorative trim panels 400g, 400h are illustrated. In FIGS. 4G and 4H, the decorative trim panels 400g, 400h are generally symmetric and include lip features on both the proximal and distal ends thereof. For instance, in FIG. 4G, a proximal finished end 420 is formed and bends at about a ninety degree angle to form a lip 421. A distal finished edge 418 may be similarly formed to provide a lip 419. In this embodiment, both lips 419, 421 may include exposed edges.

In FIG. 4H, however, the decorative trim panel 400g may include similar finished ends 422, 424; however, the lip portions 423, 425 may obscure the underlying materials. For instance, the lip portions 423, 425 may include compound bend or another type of bend or feature that allows a decorative layer or feature to be exposed when an edge surface is viewed, thereby covering or otherwise hiding one or more underlying surfaces or materials.

Although the decorative trim panels 400a-400h in FIGS. 4A-H illustrate example embodiments in which a bend or contour may be created at about a right angle, it should be appreciated that other angles may also be formed or otherwise created. In each of FIGS. 4A-4H, for example, a bend radius is approximated by using a compound bend that places one portion at about a forty-five degree angle from each of two adjacent portions. Additionally, FIGS. 4I and 4J illustrate decorative trim panels 400i, 400j that include finished distal ends 426, 430 that extend at an angle relative to the length of the decorative planar material used to produce the decorative trim panels 400i, 400j, but at an angle other than about a right angle. In FIG. 4I, for instance, a single cut 427 may be cut, produced, or otherwise produced in an exemplary decorative planar material. The distal end may be rotated relative to the proximal end. The amount of rotation may vary and may be, for example, about forty-five degrees as illustrated in FIG. 4I. In other embodiments, the finished distal end 426 may be rotated less than or more than about forty-five degrees. In still other embodiments, multiple cuts 427 may be formed to facilitate rotation of the finished distal end 426 by a degree that is more than, less than, or about equal to ninety degrees.

In FIG. 4I, the finished distal end 426 includes an exposed distal edge 428 is exposed. In some embodiments, a view of the exposed distal edge 428 may show underlying materials or have an appearance other than that which the decorative trim panel 400i is intended to provide when viewed through a coating or other layer. Accordingly, as illustrated in FIG. 4J, a decorative trim panel 400j may include a finished distal end 430 in which the distal edge 432 includes a bend, contour, or other feature that obscures the underlying or non-decorative material. For instance, in this embodiment, the distal edge 432 includes a compound bend similar to those described elsewhere herein.

The particularly illustrated and described example embodiments of decorative planar materials and/or decorative trim panels should not be viewed as exclusive. More particularly, the described and illustrated embodiments are intended to provide only some examples of numerous manners in which the methods and articles of manufacture described herein may be made, used, configured, structured, and the like. For example, while various types of finished and/or exposed proximal and distal ends and edges of decorative trim panels are described relative to FIGS. 4A-4J, the various features may be combined in any manner, to produce a wide variety of different decorative trim panels in addition to those expressly described herein, including finishing features disposed at locations other than edges. Furthermore, while FIGS. 4A-4J generally illustrate example decorative trim panels that are to scale for some embodiments of the present disclosure, they may only schematically illustrate other example embodiments of the present disclosure. For instance, the numbers, types, and/or thicknesses of layers in the decorative planar materials described herein may be altered in any number of different manners. Further, different features, edges, bends, cuts, and the like may be formed or otherwise created to have different sizes, configurations, shapes, orientations, positions, or other characteristics, or any combination thereof. Accordingly, no inference should be taken from the description and Figures that any element necessarily must have a certain size, characteristic, or feature, or must be used in connection with another feature.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A decorative planar material, comprising:
a substrate layer;
a decorative laminate layer attached to said substrate layer; and
a substantially transparent coating layer permanently attached to said decorative laminate layer.

2. The decorative planar material recited in claim 1, wherein said substrate layer and said decorative laminate layer are each separated into a plurality of portions, while said substantially transparent coating layer includes a single portion permanently attached to said plurality of portions of said decorative laminate layer.

3. The decorative planar material recited in claim 1, wherein:
one or more cuts separate said substrate layer into corresponding first and second portions and said one or more cuts separate said decorative laminate layer into corresponding first and second portions, said first and second portions of said decorative laminate being aligned with respective first and second portions of said substrate layer; and
said substantially transparent coating layer comprises a single, integral layer permanently attached to each of said first and second portions of said decorative laminate layer.

4. The decorative planar material recited in claim 3, wherein said first and second portions of said substrate layer are physically separate, and wherein said first and second portions of said decorative laminate layer are physically separate.

5. The decorative planar material recited in claim 3, wherein said second portion of said decorative laminate layer is adjacent said first portion of said decorative laminate layer, and wherein said first and second portions of said decorative laminate layers are angularly offset from each other at an obtuse angle.

6. The decorative planar material recited in claim 3, wherein said second portion of said decorative laminate layer is at about a right angle relative to said first portion of said decorative laminate layer.

7. The decorative planar material recited in claim 6, wherein a third portion of said decorative laminate layer is disposed between said first and second portions of said decorative laminate layer, said third layer defining an obtuse angle relative to each of said first and second portions of said decorative laminate layer.

8. The decorative planar material of claim 1, wherein said decorative laminate layer and said substrate layer define a beveled edge approximating a tight curve radius, wherein approximating said tight curve radius includes physically separate portions of said decorative laminate layer being angled relative to each other, while said substantially transparent coating layer maintains said physically separate portions of said decorative laminate layer adjacently positioned.

9. A decorative trim panel, comprising:
a decorative planar material composed of at least a substrate layer, a decorative layer parallel to said substrate layer, said decorative layer that includes a laminate material having a minimum allowable bend radius about at which said laminate material breaks, and a coating layer parallel to and permanently attached to said decorative layer;
at least one cut in said decorative planar material, wherein said at least one cut is formed through said substrate layer and at least a portion of said decorative layer, and without substantially extending into said coating layer; and
a finished end feature, wherein said finished end feature includes a bend in said decorative planar material at a bend radius less than said minimum allowable bend radius of said laminate material.

10. The decorative trim panel of claim 9, wherein said substrate layer is attached to a first surface of said decorative layer and said coating layer is attached to a second surface of said decorative layer which opposes said first surface of said decorative layer, and wherein said coating layer is permanently attached to substantially a full area of said second surface of said decorative layer.

11. The decorative trim panel of claim 9, wherein said at least one cut includes at least two cuts forming a substantially triangular cross-sectional shape within said substrate layer.

12. The decorative trim panel of claim 9, wherein said bend in said finished end feature is located proximate said at least one cut.

13. The decorative trim panel of claim 9, wherein said at least one cut separates said substrate layer into at least two substrate portions and said decorative layer into at least two decorative portions, wherein said at least two substrate portions and said at least two decorative portions are at an angled relative to each other at an angle about equal to or greater than ninety degrees.

14. The decorative trim panel of claim 13, wherein said angle is an obtuse angle.

15. The decorative trim panel of claim 9, wherein said coating layer comprises a flexible material and wherein said finished end feature includes said flexible material being bent proximate said at least one cut and permanently covering said at least one cut and permanently covering physically separate portions of said decorative layer.

16. A method of forming a decorative trim panel such that a laminate material in the decorative trim panel bends at a bend radius below the minimum allowable bend radius that typically causes the laminate material to break, the method comprising:
bending a decorative planar material by approximating a bend angle, wherein bending said decorative planar material includes:
forming a plurality of portions in the decorative planar material, wherein forming said plurality of portions includes:
separating a substrate layer of said decorative planar material into at least first and second substrate portions;
separating a decorative laminate layer of said decorative planar material into at least first and second decorative portions, said first and second decorative portions corresponding to said first and second substrate portions; and
maintaining an attachment between said first and second decorative portions through at least a coating layer permanently attached to said first and second decorative portions; and
rotating said second substrate portion and said second decorative portion relative to said first substrate portion and said first decorative portion.

17. The method of claim 16, further comprising finishing said bend at said approximated bend angle, wherein finishing said bend is performed automatically by said coating layer as a single portion permanently attached to said first and second decorative portions of the decorative laminate layer.

18. The method of claim 17, wherein finishing said bend is performed without removing said coating layer and without machining or grinding an external surface of the decorative trim panel.

19. The method of claim 16, wherein said coating layer maintains said first and second decorative portions adjacent each other during and after rotation of said second decorative portion relative to said first decorative portion.

20. The method of claim 16, wherein:
forming said plurality of portions includes making a plurality of cuts in said substrate layer and said decorative layer, but not through said coating layer, said plurality of cuts extending at diverging angles and defining at least a third substrate portion and a third decorative portion; and
approximating a bend angle comprises forming a beveled edge using at least a compound bend in which said second decorative portion is rotated to define an obtuse angle relative to said first decorative portion and said third decorative portion is rotated to define an obtuse angle relative to said second decorative portion and about a right angle relative to said first decorative portion.
